(19) United States
(12) Patent Application Publication
(10) Pub. No.: US 2004/0177504 A1
(43) Pub. Date: Sep. 16, 2004

(54) Method for the production of a forged piston for an internal combustion engine

(75) Inventors: Karlheinz Bing, Remseck (DE); Gerhard Bucher, Ludwigsburg (DE)

Correspondence Address: WILLIAM COLLARD, COLLARD & ROE, P.C., 1077 NORTHERN BOULEVARD, ROSLYN, NY, 11576, US

(73) Assignee: Mahle GmbH

(21) Appl. No.: 10/734,808

(22) Filed: Dec. 12, 2003

(30) Foreign Application Priority Data
Mar. 14, 2003 (DE) 103 11 148.4

(51) Int. Cl. B21K 1/18; B23P 11/00

(52) U.S. Cl. 29/888.044

(57) ABSTRACT

A method for the production of a forged piston for an internal combustion engine, having a combustion depression provided on the piston head. The piston is formed from a first tube-shaped unmachined part made of oxidation-resistant steel, having at least one join surface, and a second cylindrical unmachined part made of hot-forgeable steel, having at least one join surface. The join surface of the first unmachined part is shrunk onto the join surface of the second unmachined part. The two unmachined parts are formed to produce a piston blank, by means of forging, causing at least the combustion depression to be formed from oxidation-resistant steel. Subsequently the piston blank is finished via machining to produce a piston ready for installation in the internal combustion engine. Simplified and cost-effective production of a piston having a reduced tendency to oxidize at the edge of the depression, and improved protection against wear caused by erosion is achieved.

### BACKGROUND OF THE INVENTION

1. Field of the Invention

The invention relates to a method for the production of a forged piston for an internal combustion engine, having a combustion depression provided on the piston head, in which the piston is formed from a first cylindrical unmachined part made of oxidation-resistant steel, with at least one join surface, and a second cylindrical unmachined part made of hot-forgeable steel, with at least one join surface. The two unmachined parts are formed to produce a piston blank, by means of forging, causing at least the combustion depression to be formed of oxidation-resistant steel. Subsequently, the piston blank is finished via machining to produce a piston ready for installation in the internal combustion engine.

2. The Prior Art

In order to increase the performance of modern internal combustion engines, particularly diesel engines, the compression pressures and thereby the temperatures in the combustion space are constantly being increased. The result of this measure is that after running the engine, oxidation is found on the steel piston having a combustion depression, or on steel piston heads, which oxidation particularly occurs at the edge of the depression, as a function of the operating temperature that was reached. This oxidation can lead to the formation of cracks and thereby to failure of the component. Likewise, material wear at the piston head, along the fuel injection tracks, is also critical, and makes protection against erosion wear necessary. Known solutions for improving this situation are, for example, coating the finished piston with an oxidation-resistant layer along the edge of the depression, by plasma-spraying or application welding of more oxidation-resistant materials onto the pre-finished piston.

A method for the production of a piston or piston head for an internal combustion engine is described in PCT Application No. PCT/DE02/02768, which solves the aforementioned problem in that a ring-shaped recess is worked into the join surface of a steel unmachined part, which recess is subsequently filled with an oxidation-resistant material, by means of welding. Subsequently, the unmachined part is forged to produce a piston, and afterwards finished to produce a piston ready for installation. The result achieved by the forging, i.e. forming process, is that the oxidation-resistant material comes to rest at the edge of the combustion depression of the piston. However, the relatively large number of process steps is a disadvantage, making the production of such a piston more expensive and ineffective.

A different solution is shown by PCT Publication No. WO 02/06658 A1, in that a cylinder-shaped unmachined part made of chromium steel, i.e., an oxidation-resistant steel, is connected with a second cylinder-shaped unmachined part consisting of conventional steel (SE 4140), by means of friction welding, and subsequently formed into a piston by means of hot-forging. The piston is subsequently subjected to final finishing. A disadvantage of this process is that the two unmachined parts must be rigidly connected over a certain area, i.e. at their faces. The production method therefore requires a complicated pre-processing step for the production of a piston. In addition, because of the friction welding, a rather sizable degree of welding flash occurs on the circumference. This welding flash be removed before the forging process by lathing or grinding, since the blanks joined together in this way cannot be placed into the forging mold and the welding flash material does not permit perfect forming with a good metallic connection.

### SUMMARY OF THE INVENTION

It is therefore an object of the invention to provide a simple and cost-effective production method for a piston having a reduced tendency to oxidize at the edge of the depression, and improved protection against wear caused by erosion.

This object is achieved by a method for the production of a forged piston for an internal combustion engine, having a combustion depression provided on the piston head. The method comprises shrinking a join surface of a first tube-shaped unmachined part made of oxidation-resistant steel onto a join surface of a second cylindrical unmachined part made of hot-forgeable steel, and forging the two unmachined parts to produce a piston blank, causing at least the combustion depression to be formed from oxidation-resistant steel. The piston blank is then finished via machining to produce a piston ready for installation in the internal combustion engine.

The first unmachined part is preferably heated to 100 to 150° C. prior to the step of shrinking, and forging of the unmachined parts to produce the piston blank takes place after they have cooled to room temperature.

The join surfaces of the unmachined parts are preferably conical relative to the longitudinal axis of the unmachined parts.

By shrinking on the unmachined parts, it has surprisingly been shown that a bubble-free as well as slag-free metallic bond is produced on the piston blank after forging.

### BRIEF DESCRIPTION OF THE DRAWINGS

Other objects and features of the present invention will become apparent from the following detailed description considered in connection with the accompanying drawings. It is to be understood, however, that the drawings are designed as an illustration only and not as a definition of the limits of the invention.

In the drawings, wherein similar reference characters denote similar elements throughout the several views:

FIG. 1 shows schematically, the sequence of the production method according to the invention, in Steps A to D; and

FIG. 2 shows schematically, another variant of the production method according to the invention, in Step A.

### DETAILED DESCRIPTION OF THE PREFERRED EMBODIMENT

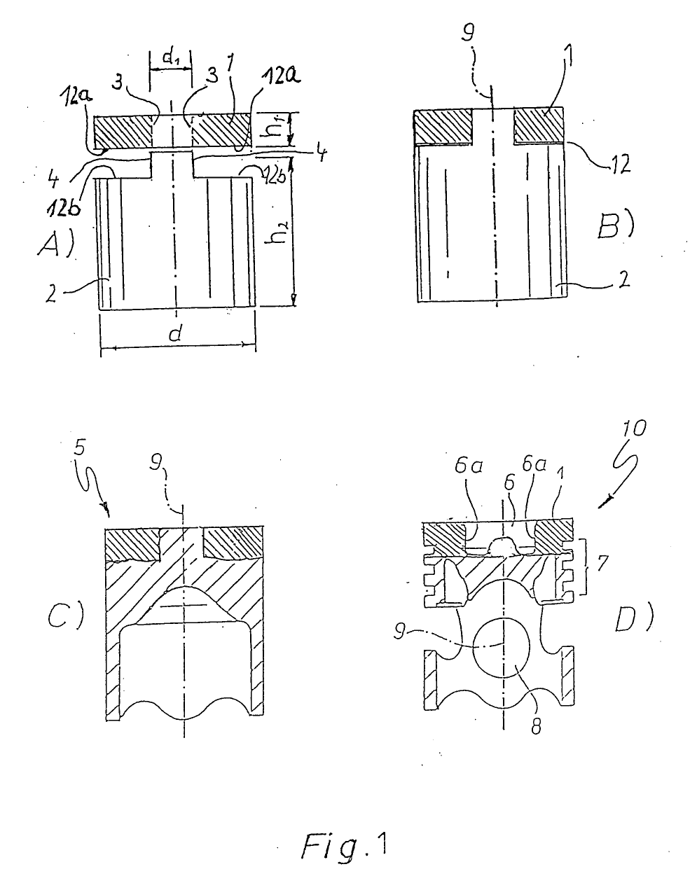

Referring now in detail to the drawings, in FIG. 1, according to method step A), a tube-shaped unmachined part made of oxidation-resistant steel, referred to as 1, has a flat face 12a as well as a join surface 3 formed by the inside wall of the unmachined part. The face surface and the join surface are formed, for example, by a lathing process. The unmachined part 1 preferably consists of a material that has improved oxidation-resistance at temperatures above 500° C., such as the steel X45CrSi9, for example, or other suitable steels, or consists of materials based on nickel, cobalt., or titanium. Another cylindrical unmachined part made of hot-forgeable steel, referred to as 2, that preferably consists of the material 42CrMo4 or 38MnSiVS5, also has a join surface 4, which is formed by the mantle surface of a tab-shaped formation at the end of unmachined part 2. The flat face of unmachined part 1, as well as radial ring surface 12b of the tab-shaped end of unmachined part 2, are oriented, relative to one another, with parallel planes, and later, in the joined state of the two unmachined parts, form a minimal parting 12. The two unmachined parts possess approximately the same outside diameter d. Fundamentally, it can be determined by way of height h₁ and inside diameter d₁ of unmachined part 1 what piston regions of piston 10, such as depression edge region 6a, complete combustion depression 6, or also parts of ring part 7, are supposed to consist of oxidation-resistant material.

In method step B), unmachined part 1 is pushed onto unmachined part 2, until a minimal parting 12 is reached, without force. Unmachined part 1 is heated up as it is being pushed on, i.e. shrunk on, for example to a temperature of 100 to 150° C. In addition, unmachined part 2 can also be cooled, for example to −100 to −150° C., but such cooling is not necessary for successfully implementing the method.

Forming of unmachined parts 1 and 2, which have been welded to one another on their circumference, to produce a piston blank 5, is carried out by means of known forging methods, as shown in method step C) of FIG. 1. In this connection, the connected unmachined parts can be cooled to room temperature, or can still be in the warm state, after fixation has taken place by means of shrinking.

The actual “welding together” of the unmachined parts 1 and 2 takes place as a result of the forging process, by means of the formation of a join. The oxidation-resistant material, in other words the unmachined part 1, is formed in such a way that it comes to rest in the region of the resulting depression edge 6a, i.e. the entire combustion depression 6. Local flow of the material as a result of the forging process, into the region of ring part 7, can also not be precluded. During subsequent cooling from the forging heat, the temperature is conducted in such a way that the two steel materials are present in the desired heat treatment state.

Subsequently, finishing of the piston blank to produce a piston 10 that can be used in an internal combustion engine, having the desired combustion depression 6, ring part 7, pin hub 8, etc., takes place by machining.

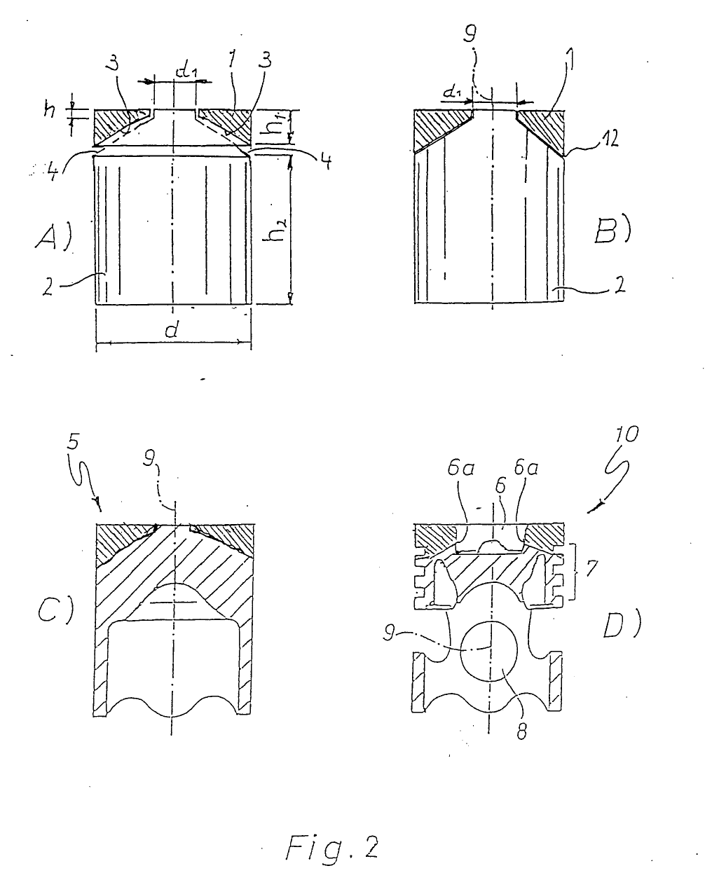

In another exemplary embodiment according to method step A) according to FIG. 2, the tube-shaped unmachined part 1 is provided with a join surface 3 that is conical relative to the plane of longitudinal axis 9 of the unmachined part which, at its rising end, makes a transition into a cylindrical bore surface having a height h and diameter d₁. By way of a join surface 4 of unmachined part 2, which makes a transition into a cylindrical mantle surface of a step having the diameter d₁ and height h, also at its rising end, joining of the two unmachined parts takes place by a shrink fit, in such a manner that the join surfaces 3 and 4, with their diameters d₁, form a minimal projection relative to one another. For this purpose, the two unmachined parts 1 and 2 are subjected to heat treatment analogous to the aforementioned first exemplary embodiment. Depending on inside diameter d₁ and height h₁ of tube-shaped unmachined part 1, it is determined whether the complete depression edge 6a, only the upper part of the depression edge that reaches to the combustion space or, in addition, also part of ring part 7 consists of the oxidation-resistant material.

It lies within the scope of the invention that the production method according to the invention can also be carried out using forged unmachined parts 1 and 2.

Accordingly, while only a few embodiments of the present invention have been shown and described, it is obvious that many changes and modifications may be made thereunto without departing from the spirit and scope of the invention.

Reference Symbols

Tube-shaped unmachined part made of oxidation-resistant steel 1

Cylindrical unmachined part made of hot-forgeable steel 2

Join surface of the unmachined part 1 3

Join surface of the unmachined part 2 4

Piston blank 5

Combustion depression 6

Depression edge 6a

Ring part 7

Pin hub 8

Longitudinal axis of the unmachined parts 1, 2 9

Piston 10

Parting 12

Face 12a

Ring surface 12b

Diameter of the unmachined parts 1, 2 d

Inside diameter of the unmachined part 1 d₁

Height of the unmachined parts h_{1, 2}

Height h

What is claimed is:

1. Method for the production of a forged piston for an internal combustion engine, having a combustion depression provided on the piston head, comprising
shrinking a join surface of a first tube-shaped unmachined part made of oxidation-resistant steel onto a join surface of a second cylindrical unmachined part made of hot-forgeable steel;
forging the two unmachined parts to produce a piston blank, causing at least the combustion depression to be formed from oxidation-resistant steel; and
finishing the piston blank via machining to produce a piston ready for installation in the internal combustion engine.

2. A method according to claim 1, wherein the first unmachined part is heated to 100 to 150° C. prior to the step of shrinking.

3. A method according to claim 2, wherein forging of the unmachined parts to produce a piston blank takes place after the parts have cooled to room temperature.

4. A method according to claim 1, wherein the join surfaces of the unmachined parts are conical relative to a longitudinal axis of the unmachined parts.
